(19) United States
(12) Patent Application Publication
(10) Pub. No.: US 2026/0128787 A1
(43) Pub. Date: May 7, 2026

(54) METHOD AND APPARATUS FOR ACCESSING NON-TERRESTRIAL NETWORKS

(71) Applicant: HUAWEI TECHNOLOGIES CO., LTD., Shenzhen (CN)

(72) Inventors: Chuili Kong, Hangzhou (CN); Hejia Luo, Ottawa (CA); Kexin Li, Shenzhen (CN); Yu Wang, Hangzhou (CN); Jun Wang, Hangzhou (CN)

(21) Appl. No.: 19/435,182

(22) Filed: Dec. 29, 2025

Related U.S. Application Data
(63) Continuation of application No. PCT/CN2023/104414, filed on Jun. 30, 2023.

(51) Int. Cl. H04B 7/185; H04B 17/318

(52) U.S. Cl. CPC H04B 7/1855; H04B 7/18523; H04B 17/328

(57) ABSTRACT

This disclosure provides a communication method for a radio access network and a core network, and an associated communication apparatus. A terminal device may determine a first reference point list, where the first reference point list includes points at which a plurality of beams are projected onto the ground; and determine a second beam based on the first reference point list and a movement direction of a first satellite. When an access beam is selected, the movement direction of the first satellite is considered, so that a beam switching problem in an access process caused by satellite movement can be avoided. A broadcast beam with a largest beam coverage area in the movement direction is selected based on a reference point in the first reference point list, to ensure smooth access.

### CROSS-REFERENCE TO RELATED APPLICATIONS

This application is a continuation of International Application No. PCT/CN2023/104414, filed on Jun. 30, 2023, the disclosure of which is hereby incorporated by reference in its entirety.

### TECHNICAL FIELD

This disclosure relates to satellite networks, and more specifically, to a method for accessing a non-terrestrial network (NTN) and an associated communication apparatus.

### BACKGROUND

A non-terrestrial network (NTN) like satellite communication has significant advantages such as global coverage, long-distance transmission, flexible networking, convenient deployment, and no limitation from geographical conditions, and has been widely applied to a plurality of fields such as maritime communication, positioning and navigation, disaster relief, scientific experiments, video broadcasting, and earth observation.

A current new radio (NR) beam sweeping solution is not applicable to an NTN system. For an NTN communication system, when remaining service time of a beam corresponding to a synchronization signal block (SSB) selected by a terminal device (UE) is less than access time of the UE, in a UE access process, beam switching is caused by satellite movement, resulting in a UE access interruption.

### SUMMARY

Embodiments of this disclosure provide a method for accessing an NTN and a communication apparatus, to ensure that a UE can select a proper beam and complete access under one beam, thereby avoiding beam switching in an access process and ensuring smooth access.

According to a first aspect, a method for accessing an NTN is provided. The method may be performed by a terminal device, or may be performed by a chip or a circuit configured in the terminal device. This is not limited in this disclosure.

The method includes: determining a first reference point list, where the first reference point list includes a plurality of first reference points, the first reference points are points within beam coverage areas of first beams projected onto the ground, the plurality of first beams are in one-to-one correspondence with the plurality of first reference points, and the plurality of first reference points are at same relative positions within the beam coverage areas; and determining a second beam based on the first reference point list and a movement direction of a first satellite, where the second beam is one of the plurality of first beams, and the second beam is used to access the satellite.

In this technical solution, the terminal device may determine the first reference point list, where the first reference point list includes points at which a plurality of beams are projected onto the ground; and determine the second beam based on the first reference point list and the movement direction of the first satellite. It should be understood that when an access beam is selected, the movement direction of the first satellite is considered, so that a beam switching problem in an access process caused by satellite movement can be avoided, to ensure smooth access.

With reference to the first aspect, in an implementation of the first aspect, the first reference point list is received from an access network device by using a broadcast message.

In this technical solution, the terminal device may receive, by using the broadcast message, the first reference point list sent by the access network device.

The broadcast message may be carried by using a SIB 19, or another system information block (SIB) message. This is not limited in this embodiment of this disclosure.

With reference to the first aspect, in an implementation of the first aspect, a first beam direction list is received from an access network device by using a broadcast message, where the first beam direction list includes directions of the plurality of first beams, and the direction of the first beam indicates an elevation angle and an azimuth angle of the first beam; and the first reference point list is determined based on the first beam direction list, where the directions of the plurality of first beams are in one-to-one correspondence with the plurality of first reference points.

This technical solution is another manner in which the terminal device determines the first reference point list. The access network device sends the first beam direction list to the terminal device. The first beam direction list indicates the directions of the plurality of beams. The terminal device may determine corresponding reference points based on the directions of the plurality of beams, to determine the first reference point list.

According to this technical solution, the terminal device may select a broadcast beam with a largest beam coverage area in the movement direction based on a reference point in the first reference point list, to avoid the beam switching problem in the access process caused by the satellite movement, and ensure the smooth access.

With reference to the first aspect, in an implementation of the first aspect, beam width information and beam index list information from an access network device are received by using a broadcast message, where the beam width information indicates a beam width of the first beam from the first satellite; and the first reference point list is determined based on the beam width information and the beam index list information.

This technical solution is another manner in which the terminal device determines the first reference point list. The access network device sends the beam width information and the beam index list information to the terminal device, and the terminal device may determine a corresponding reference point based on the beam width information and the beam index list information, to determine the first reference point list.

According to this technical solution, the terminal device may select a broadcast beam with a largest beam coverage area in the movement direction based on a reference point in the first reference point list, to avoid the beam switching problem in the access process caused by the satellite movement, and ensure the smooth access.

With reference to the first aspect, in an implementation of the first aspect, the first beam is a beam corresponding to a subsatellite point.

The beam width information indicates a beam width of the beam corresponding to the subsatellite point from the first satellite, or may indicate a beam width of any first beam from the first satellite.

With reference to the first aspect, in an implementation of the first aspect, a beam arrangement manner is determined based on the beam width information and the beam index list information, where the beam arrangement manner indicates positions of the plurality of first beams projected onto the ground; and the first reference point list is determined based on the beam arrangement manner.

In this technical solution, the beam arrangement manner may be determined based on the beam width information and the beam index list information, so that the positions of the plurality of first beams projected onto the ground may be determined, and a reference point corresponding to each beam may be further directly determined.

With reference to the first aspect, in an implementation of the first aspect, the beam arrangement manner is determined based on the beam width information and the beam index list information and according to a first rule, where the first rule is a beam arrangement rule; or the beam arrangement manner is determined based on the beam width information, the beam index list information, and a first pattern, where the first pattern indicates arrangement of the beam indexes.

In this technical solution, the beam arrangement manner is determined according to the predefined or preconfigured first rule or a fixed pattern.

With reference to the first aspect, in an implementation of the first aspect, first indication information from the access network device is received by using the broadcast message, where the first indication information indicates the first pattern.

With reference to the first aspect, in an implementation of the first aspect, a first vector set is determined based on position information of the terminal device and ephemeris information of the first satellite, where the first vector set includes a plurality of first vectors, an initial point of the first vector is a position of the terminal device, and an end point of the first vector is a second reference point; a first scalar set is determined based on the first vector set and the movement direction of the first satellite, where the first scalar set includes a plurality of first scalars, and the first scalar is a projection distance of the first vector in the movement direction of the first satellite; and the second beam is determined based on the first scalar set.

According to the technical solution, the terminal device may obtain auxiliary information, calculate vectors between the position of the terminal device and different beam reference points, obtain a projection distance of the vector in a satellite movement direction, and determine the second beam based on the projection distance, to perform access. A broadcast beam with a largest beam coverage area in the movement direction is selected, to avoid a beam switching problem in an access process caused by satellite movement, and ensure smooth access.

With reference to the first aspect, in an implementation of the first aspect, the second reference point is any reference point in the first reference point list, or the second reference point is any reference point in a second reference point list, the second reference point list is a subset or a universal set of the first reference point list, the second reference point list includes the plurality of first reference points, and the first beams corresponding to the plurality of first reference points included in the second reference point list satisfy a reference signal received power (RSRP) threshold.

It should be understood that, when selecting a beam for accessing the first satellite, the terminal device may determine the beam based on the RSRP threshold. Before determining the first vector set, the terminal device may first select, from beams corresponding to the plurality of first reference points in the first reference point list, a plurality of first reference points corresponding to beams that satisfy the RSRP threshold to form the second reference point list.

In this technical solution, after determining the first reference point list, the terminal device may first screen out a beam that does not satisfy the RSRP threshold from the first reference point list, to simplify a subsequent implementation process, or may not consider a beam of the RSRP threshold. This solution may be flexibly selected based on a specific implementation requirement, to be applicable to more scenarios.

With reference to the first aspect, in an implementation of the first aspect, a second scalar set is determined based on the first scalar set, where the second scalar set is a subset or a universal set of the first scalar set, and beams corresponding to the plurality of first scalars included in the second scalar set satisfy the RSRP threshold; and a beam corresponding to a smallest first scalar in the plurality of first scalars in the second scalar set is determined as the second beam.

In this technical solution, the RSRP threshold may also be referred to when the second scalar set is determined, and a beam corresponding to the second scalar set may be a beam that satisfies the RSRP threshold.

With reference to the first aspect, in an implementation of the first aspect, a beam corresponding to a smallest first scalar in the plurality of first scalars in the first scalar set is determined as the second beam.

In this technical solution, the beam corresponding to the smallest first scalar in the plurality of first scalars has a largest coverage area in the movement direction of the first satellite. Therefore, it can be ensured that the terminal device completes a switching process in a same beam as much as possible, to ensure smooth access.

With reference to the first aspect, in an implementation of the first aspect, a second scalar set is determined based on the first scalar set, where the second scalar set is a subset or a universal set of the first scalar set, and beams corresponding to the plurality of first scalars included in the second scalar set satisfy the RSRP threshold; at least one first scalar that satisfies a first threshold in the plurality of first scalars in the second scalar set is determined; and a beam corresponding to one of the at least one first scalar is determined as the second beam.

In this technical solution, the RSRP is not considered when the first vector set is determined. Therefore, it is necessary to consider whether a beam corresponding to the first scalar set satisfies the RSRP, and then a beam that satisfies the first threshold is selected as the second beam.

With reference to the first aspect, in an implementation of the first aspect, at least one first scalar that satisfies a first threshold in the plurality of first scalars in the first scalar set is determined; and a beam corresponding to one of the at least one first scalar is determined as the second beam.

In this technical solution, the RSRP is already considered when the first vector set is determined. Therefore, a beam that satisfies the first threshold is directly selected from the first scalar set as the second beam.

With reference to the first aspect, in an implementation of the first aspect, the first threshold from the access network device is received.

According to a second aspect, a method for accessing an NTN is provided. The method may be performed by an access network device, or may be performed by a chip or a circuit configured in the access network device. This is not limited in this disclosure.

The method includes: determining a first reference point list, where the first reference point list includes a plurality of first reference points, the first reference points are points within beam coverage areas of first beams projected onto the ground, the first beam is any one of a plurality of first beams determined by a first satellite, the plurality of first beams are in one-to-one correspondence with the plurality of first reference points, and the plurality of first reference points are at same relative positions within the beam coverage areas; and sending the first reference point list by using a broadcast message.

In this technical solution, the access network device may explicitly indicate the first reference point list to the terminal device, where the first reference point list includes points at which a plurality of beams are projected onto the ground; and determine a second beam based on the first reference point list and a movement direction of the first satellite. It should be understood that when an access beam is selected, the movement direction of the first satellite is considered, so that a beam switching problem in an access process caused by satellite movement can be avoided, to ensure smooth access.

With reference to the second aspect, in an implementation of the second aspect, a first threshold is sent by using the broadcast message, where the first threshold is used by the terminal device to determine the second beam, and the second beam is used to access the first satellite.

According to a third aspect, a method for accessing an NTN is provided. The method may be performed by an access network device, or may be performed by a chip or a circuit configured in the access network device. This is not limited in this disclosure.

The method includes: determining a first beam direction list, where the first beam direction list includes directions of the plurality of first beams, and the direction of the first beam indicates an elevation angle and an azimuth angle of the first beam; and sending the first beam direction list by using a broadcast message.

In this technical solution, the access network device may explicitly indicate the first beam direction list to the terminal device, so that the terminal device determines the first reference point list, where the first reference point list includes points at which a plurality of beams are projected onto the ground; and determine a second beam based on the first reference point list and a movement direction of a first satellite. It should be understood that when an access beam is selected, the movement direction of the first satellite is considered, so that a beam switching problem in an access process caused by satellite movement can be avoided, to ensure smooth access.

With reference to the third aspect, in an implementation of the third aspect, a first threshold is sent by using the broadcast message, where the first threshold is used by the terminal device to determine the second beam, and the second beam is used to access the first satellite.

According to a fourth aspect, a method for accessing an NTN is provided. The method may be performed by an access network device, or may be performed by a chip or a circuit configured in the access network device. This is not limited in this disclosure.

The method includes: determining beam width information and beam index list information, where the beam width information indicates a beam width of the first beam from the first satellite; and sending the beam width information and the beam index list information by using a broadcast message.

In this technical solution, the access network device may explicitly indicate the beam width information and the beam index list information to the terminal device, so that the terminal device determines a first reference point list, where the first reference point list includes points at which a plurality of beams are projected onto the ground; and determine a second beam based on the first reference point list and a movement direction of the first satellite. It should be understood that when an access beam is selected, the movement direction of the first satellite is considered, so that a beam switching problem in an access process caused by satellite movement can be avoided, to ensure smooth access.

With reference to the fourth aspect, in an implementation of the fourth aspect, first indication information is sent by using the broadcast message, where the first indication information indicates a first pattern, and the first pattern indicates arrangement of the beam indexes.

With reference to the fourth aspect, in an implementation of the fourth aspect, a first threshold is sent by using the broadcast message, where the first threshold is used by the terminal device to determine the second beam, and the second beam is used to access the first satellite.

According to a fifth aspect, a communication apparatus is provided. The apparatus may be a terminal device, or may be a chip or circuit configured in the terminal device. This is not limited in this disclosure.

The apparatus includes: a processing unit, configured to determine a first reference point list, where the first reference point list includes a plurality of first reference points, the first reference points are points within beam coverage areas of first beams projected onto the ground, the first beam is any one of a plurality of first beams determined by a first satellite, the plurality of first beams are in one-to-one correspondence with the plurality of first reference points, and the plurality of first reference points are at same relative positions within the beam coverage areas. The processing unit is further configured to determine a second beam based on the first reference point list and a movement direction of the first satellite, where the second beam is used to access the first satellite.

In this technical solution, the terminal device may determine the first reference point list, where the first reference point list includes points at which a plurality of beams are projected onto the ground; and determine the second beam based on the first reference point list and the movement direction of the first satellite. It should be understood that when an access beam is selected, the movement direction of the first satellite is considered, so that a beam switching problem in an access process caused by satellite movement can be avoided, to ensure smooth access.

With reference to the fifth aspect, in an implementation of the fifth aspect, the communication apparatus further includes a transceiver unit, configured to receive the first reference point list from an access network device by using a broadcast message.

In this technical solution, the terminal device may receive, by using the broadcast message, the first reference point list sent by the access network device.

The broadcast message may be carried by using a SIB 19, or another SIB message. This is not limited in this embodiment of this disclosure.

With reference to the fifth aspect, in an implementation of the fifth aspect, the transceiver unit is further configured to receive a first beam direction list from an access network device by using a broadcast message, where the first beam direction list includes directions of the plurality of first beams, and the direction of the first beam indicates an elevation angle and an azimuth angle of the first beam; and the processing unit is further configured to determine the first reference point list based on the first beam direction list, where the directions of the plurality of first beams are in one-to-one correspondence with the plurality of first reference points.

This technical solution is another manner in which the terminal device determines the first reference point list. The access network device sends the first beam direction list to the terminal device. The first beam direction list indicates the directions of the plurality of beams. The terminal device may determine corresponding reference points based on the directions of the plurality of beams, to determine the first reference point list.

According to this technical solution, the terminal device may select a broadcast beam with a largest beam coverage area in the movement direction based on a reference point in the first reference point list, to avoid the beam switching problem in the access process caused by the satellite movement, and ensure the smooth access.

With reference to the fifth aspect, in an implementation of the fifth aspect, the transceiver unit is further configured to receive beam width information and beam index list information from an access network device by using a broadcast message, where the beam width information indicates a beam width of the first beam from the first satellite; and the processing unit is further configured to determine the first reference point list based on the beam width information and the beam index list information.

This technical solution is another manner in which the terminal device determines the first reference point list. The access network device sends the beam width information and the beam index list information to the terminal device, and the terminal device may determine a corresponding reference point based on the beam width information and the beam index list information, to determine the first reference point list.

According to this technical solution, the terminal device may select a broadcast beam with a largest beam coverage area in the movement direction based on a reference point in the first reference point list, to avoid the beam switching problem in the access process caused by the satellite movement, and ensure the smooth access.

With reference to the fifth aspect, in an implementation of the fifth aspect, the first beam is a beam corresponding to a subsatellite point.

The beam width information indicates a beam width of the beam corresponding to the subsatellite point from the first satellite, or may indicate a beam width of any first beam from the first satellite.

With reference to the fifth aspect, in an implementation of the fifth aspect, the processing unit is further configured to determine a beam arrangement manner based on the beam width information and the beam index list information, where the beam arrangement manner indicates positions of the plurality of first beams projected onto the ground; and the processing unit is further configured to determine the first reference point list based on the beam arrangement manner.

In this technical solution, the beam arrangement manner may be determined based on the beam width information and the beam index list information, so that the positions of the plurality of first beams projected onto the ground may be determined, and a reference point corresponding to each beam may be further directly determined.

With reference to the fifth aspect, in an implementation of the fifth aspect, the processing unit is specifically configured to determine the beam arrangement manner based on the beam width information and the beam index list information and according to a first rule, where the first rule is a beam arrangement rule; or the processing unit is specifically configured to determine the beam arrangement manner based on the beam width information, the beam index list information, and a first pattern, where the first pattern indicates arrangement of the beam indexes.

In this technical solution, the beam arrangement manner is determined according to the predefined or preconfigured first rule or a fixed pattern.

With reference to the fifth aspect, in an implementation of the fifth aspect, the transceiver unit is further configured to receive first indication information from the access network device by using the broadcast message, where the first indication information indicates the first pattern.

With reference to the fifth aspect, in an implementation of the fifth aspect, the processing unit is further configured to determine a first vector set based on position information of the terminal device and ephemeris information of the first satellite, where the first vector set includes a plurality of first vectors, an initial point of the first vector is a position of the terminal device, and an end point of the first vector is a second reference point; the processing unit is further configured to determine a first scalar set based on the first vector set and the movement direction of the first satellite, where the first scalar set includes a plurality of first scalars, and the first scalar is a projection distance of the first vector in the movement direction of the first satellite; and the processing unit is further configured to determine the second beam based on the first scalar set.

According to the technical solution, the terminal device may obtain auxiliary information, calculate vectors between the position of the terminal device and different beam reference points, obtain a projection distance of the vector in a satellite movement direction, and determine the second beam based on the projection distance, to perform access. A broadcast beam with a largest beam coverage area in the movement direction is selected, to avoid a beam switching problem in an access process caused by satellite movement, and ensure smooth access.

With reference to the fifth aspect, in an implementation of the fifth aspect, the second reference point is any reference point in the first reference point list, or the second reference point is any reference point in a second reference point list, the second reference point list is a subset or a universal set of the first reference point list, the second reference point list includes the plurality of first reference points, and the first beams corresponding to the plurality of first reference points included in the second reference point list satisfy an RSRP threshold.

It should be understood that, when selecting a beam for accessing the first satellite, the terminal device may determine the beam based on the RSRP threshold. Before determining the first vector set, the terminal device may first select, from beams corresponding to the plurality of first reference points in the first reference point list, a plurality of first reference points corresponding to beams that satisfy the RSRP threshold to form the second reference point list.

In this technical solution, after determining the first reference point list, the terminal device may first screen out a beam that does not satisfy the RSRP threshold from the first reference point list, to simplify a subsequent implementation process, or may not consider a beam of the RSRP threshold. This solution may be flexibly selected based on a specific implementation requirement, to be applicable to more scenarios.

With reference to the fifth aspect, in an implementation of the fifth aspect, the processing unit is further configured to determine a second scalar set based on the first scalar set, where the second scalar set is a subset or a universal set of the first scalar set, and beams corresponding to the plurality of first scalars included in the second scalar set satisfy the RSRP threshold; and the processing unit is further configured to determine a beam corresponding to a smallest first scalar in the plurality of first scalars in the second scalar set as the second beam.

In this technical solution, the RSRP threshold may also be referred to when the second scalar set is determined, and a beam corresponding to the second scalar set may be a beam that satisfies the RSRP threshold.

With reference to the fifth aspect, in an implementation of the fifth aspect, the processing unit is further configured to determine a beam corresponding to a smallest first scalar in the plurality of first scalars in the first scalar set as the second beam.

In this technical solution, the beam corresponding to the smallest first scalar in the plurality of first scalars has a largest coverage area in the movement direction of the first satellite. Therefore, it can be ensured that the terminal device completes a switching process in a same beam as much as possible, to ensure smooth access.

With reference to the fifth aspect, in an implementation of the fifth aspect, the processing unit is further configured to determine a second scalar set based on the first scalar set, where the second scalar set is a subset or a universal set of the first scalar set, and beams corresponding to the plurality of first scalars included in the second scalar set satisfy the RSRP threshold; the processing unit is further configured to determine at least one first scalar that satisfies a first threshold in the plurality of first scalars in the second scalar set; and the processing unit is further configured to determine a beam corresponding to one of the at least one first scalar as the second beam.

In this technical solution, the RSRP is not considered when the first vector set is determined. Therefore, it is necessary to consider whether a beam corresponding to the first scalar set satisfies the RSRP, and then a beam that satisfies the first threshold is selected as the second beam.

With reference to the fifth aspect, in an implementation of the fifth aspect, the processing unit is further configured to determine at least one first scalar that satisfies a first threshold in the plurality of first scalars in the first scalar set; and the processing unit is further configured to determine a beam corresponding to one of the at least one first scalar as the second beam.

In this technical solution, the RSRP is already considered when the first vector set is determined. Therefore, a beam that satisfies the first threshold is directly selected from the first scalar set as the second beam.

With reference to the fifth aspect, in an implementation of the fifth aspect, the transceiver unit is further configured to receive the first threshold from the access network device.

According to a sixth aspect, a communication apparatus is provided. The apparatus may be an access network device, or may be a chip or a circuit configured in the access network device. This is not limited in this disclosure.

The apparatus includes: a processing unit, configured to determine a first reference point list, where the first reference point list includes a plurality of first reference points, the first reference points are points within beam coverage areas of first beams projected onto the ground, the first beam is any one of a plurality of first beams determined by a first satellite, the plurality of first beams are in one-to-one correspondence with the plurality of first reference points, and the plurality of first reference points are at same relative positions within the beam coverage areas; and a transceiver unit, configured to send the first reference point list by using a broadcast message.

In this technical solution, the access network device may explicitly indicate the first reference point list to the terminal device, where the first reference point list includes points at which a plurality of beams are projected onto the ground; and determine a second beam based on the first reference point list and a movement direction of the first satellite. It should be understood that when an access beam is selected, the movement direction of the first satellite is considered, so that a beam switching problem in an access process caused by satellite movement can be avoided. A broadcast beam with a largest beam coverage area in the movement direction is selected based on a reference point in the first reference point list, to ensure smooth access.

With reference to the sixth aspect, in an implementation of the sixth aspect, the transceiver unit is further configured to send a first threshold by using the broadcast message, where the first threshold is used by the terminal device to determine the second beam, and the second beam is used to access the first satellite.

According to a seventh aspect, a communication apparatus is provided. The apparatus may be an access network device, or may be a chip or a circuit configured in the access network device. This is not limited in this disclosure.

The apparatus includes: a processing unit, configured to determine a first beam direction list, where the first beam direction list includes directions of the plurality of first beams, and the direction of the first beam indicates an elevation angle and an azimuth angle of the first beam; and a transceiver unit, configured to send the first beam direction list by using a broadcast message.

In this technical solution, the access network device may explicitly indicate the first beam direction list to the terminal device, so that the terminal device determines the first reference point list, where the first reference point list includes points at which a plurality of beams are projected onto the ground; and determine a second beam based on the first reference point list and a movement direction of a first satellite. It should be understood that when an access beam is selected, the movement direction of the first satellite is considered, so that a beam switching problem in an access process caused by satellite movement can be avoided. A broadcast beam with a largest beam coverage area in the movement direction is selected based on a reference point in the first reference point list, to ensure smooth access.

With reference to the seventh aspect, in an implementation of the seventh aspect, the transceiver unit is further configured to send a first threshold by using the broadcast message, where the first threshold is used by the terminal device to determine the second beam, and the second beam is used to access the first satellite.

According to an eighth aspect, a communication apparatus is provided. The apparatus may be an access network device, or may be a chip or a circuit configured in the access network device. This is not limited in this disclosure.

The apparatus includes: a processing unit, configured to determine beam width information and beam index list information, where the beam width information indicates a beam width of the first beam from the first satellite; and a transceiver unit, configured to send the beam width information and the beam index list information by using a broadcast message.

In this technical solution, the access network device may explicitly indicate the beam width information and the beam index list information to the terminal device, so that the terminal device determines a first reference point list, where the first reference point list includes points at which a plurality of beams are projected onto the ground; and determine a second beam based on the first reference point list and a movement direction of the first satellite. It should be understood that when an access beam is selected, the movement direction of the first satellite is considered, so that a beam switching problem in an access process caused by satellite movement can be avoided. A broadcast beam with a largest beam coverage area in the movement direction is selected based on a reference point in the first reference point list, to ensure smooth access.

With reference to the eighth aspect, in an implementation of the eighth aspect, the transceiver unit is further configured to send first indication information by using the broadcast message, where the first indication information indicates a first pattern, and the first pattern indicates arrangement of the beam indexes.

With reference to the eighth aspect, in an implementation of the eighth aspect, the transceiver unit is further configured to send a first threshold by using the broadcast message, where the first threshold is used by the terminal device to determine the second beam, and the second beam is used to access the first satellite.

According to a ninth aspect, this disclosure provides a processor for performing the methods provided in the foregoing aspects.

Operations such as sending and obtaining/receiving related to the processor may be understood as operations such as output and receiving or input of the processor, or operations such as sending and receiving performed by a radio frequency circuit and an antenna, unless otherwise specified, or provided that the operations do not contradict actual functions or internal logic of the operations in related descriptions. This is not limited in this disclosure.

According to a tenth aspect, this disclosure provides a communication apparatus. The apparatus includes: a memory, configured to store a program; and at least one processor, configured to execute a computer program or instructions stored in the memory, to perform the method provided in any one of the foregoing aspects or the implementations of the foregoing aspects.

According to an eleventh aspect, this disclosure provides a computer-readable storage medium. The computer-readable medium stores program code to be executed by a device, and the program code is for performing the method provided in any one of the foregoing aspects or the implementations of the foregoing aspects.

According to a twelfth aspect, this disclosure provides a computer program product including instructions. When the computer program product runs on a computer, the computer is caused to perform the method provided in any one of the foregoing aspects or the implementations of the foregoing aspects.

According to a thirteenth aspect, this disclosure provides a chip. The chip includes a processor and a communication interface. The processor reads, through the communication interface, instructions stored in a memory, to perform the method provided in any one of the foregoing aspects or the implementations of the foregoing aspects.

Optionally, in an implementation, the chip further includes the memory. The memory stores a computer program or the instructions. The processor is configured to execute the computer program or the instructions stored in the memory. When the computer program or the instructions are executed, the processor is configured to perform the method provided in any one of the foregoing aspects or the implementations of the foregoing aspects.

### BRIEF DESCRIPTION OF DRAWINGS

FIG. 1 is a diagram of a communication system to which an embodiment of this disclosure is applicable;

FIG. 2 is a diagram of an application architecture to which an embodiment of this disclosure is applicable;

FIG. 3 is a diagram of satellite broadcast beam sweeping to which an embodiment of this disclosure is applicable;

FIG. 4 is a diagram of satellite broadcast beam sweeping to which an embodiment of this disclosure is applicable;

FIG. 5 is a diagram of UE beam selection in an NTN system to which an embodiment of this disclosure is applicable;

FIG. 6 is a diagram of a method for accessing an NTN to which an embodiment of this disclosure is applicable;

FIG. 7 is a diagram of a first reference point to which an embodiment of this disclosure is applicable;

FIG. 8 is a diagram of a direction of a first beam to which an embodiment of this disclosure is applicable;

FIG. 9 is a simulation diagram of determining a beam index list based on a beam width to which an embodiment of this disclosure is applicable;

FIG. 10 is a simulation diagram of a number of beams and a beam width to which an embodiment of this disclosure is applicable;

FIG. 11 is a diagram of a beam arrangement manner to which an embodiment of this disclosure is applicable;

FIG. 12 is a diagram of a method for determining a second beam to which an embodiment of this disclosure is applicable;

FIG. 13 is a diagram of a structure of a communication apparatus 1300 according to an embodiment of this disclosure; and

FIG. 14 is a diagram of a structure of a communication apparatus 1400 according to an embodiment of this disclosure.

### DESCRIPTION OF EXAMPLE EMBODIMENTS

The following describes technical solutions of this disclosure with reference to accompanying drawings.

The technical solutions of this disclosure may be applied to a non-terrestrial network (NTN) system like a satellite communication system or a high altitude platform station (HAPS) communication system, for example, an integrated communication and navigation (ICaN) system or a global navigation satellite system (GNSS).

The satellite communication system may be integrated with a conventional mobile communication system. For example, the mobile communication system may be a 4th generation (4G) communication system (for example, a long term evolution (LTE) system), a worldwide interoperability for microwave access (WiMAX) communication system, a 5th generation (5G) communication system (for example, a new radio (NR) system), a future mobile communication system, and the like.

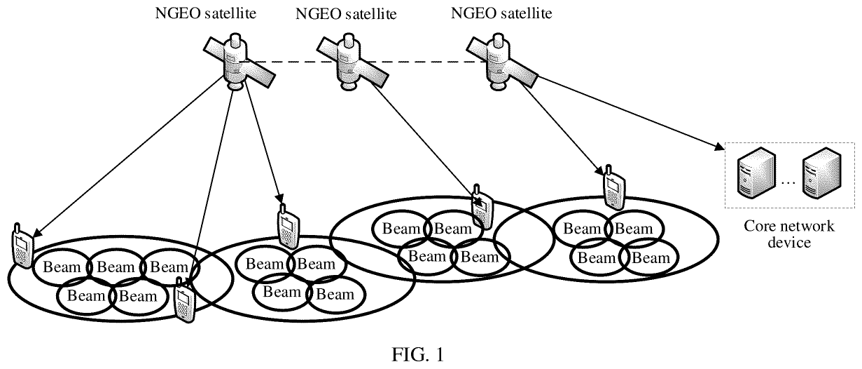

FIG. 1 is a diagram of a communication system 100 to which an embodiment of this disclosure is applicable. As shown in FIG. 1, a satellite provides a communication service for a terminal device by using a plurality of beams. The satellite in this scenario is a non-geostationary orbit (NGEO) satellite, and the satellite is connected to a core network device. The satellite uses the plurality of beams to cover a service area, and different beams may be used to perform communication in one or more manners of time division, frequency division, and space division. The satellite provides communication and navigation services for the terminal device by broadcasting a communication signal and a navigation signal. The satellite mentioned in this embodiment of this disclosure may alternatively be a satellite base station or a network side device mounted on a satellite.

The terminal device mentioned in this embodiment of this disclosure includes various handheld devices, vehicle-mounted devices, wearable devices, or computing devices that have a wireless communication function, or other processing devices connected to a wireless modem, and may be specifically a user equipment (UE), an access terminal, a subscriber unit, a subscriber station, a mobile station, a remote station, a remote terminal, a mobile device, a user terminal, a terminal, a wireless communication device, a user agent, or a user apparatus. The terminal device may alternatively be a satellite phone, a cellular phone, a smartphone, a wireless data card, a wireless modem, a machine-type communication device, a cordless phone, a session initiation protocol (SIP) phone, a wireless local loop (WLL) station, a personal digital assistant (PDA), a handheld device or a computing device having a wireless communication function or another processing device connected to a wireless modem, a vehicle-mounted device or a wearable device, a virtual reality (VR) terminal device, an augmented reality (AR) terminal device, a wireless terminal in industrial control, a wireless terminal in self-driving, a wireless terminal in telemedicine, a wireless terminal in a smart grid, a wireless terminal in transportation safety, a wireless terminal in a smart city, a wireless terminal in a smart home, a terminal device in a 5G network or a future communication network, or the like.

FIG. 2 is a diagram of an application architecture to which an embodiment of this disclosure is applicable. A terrestrial mobile terminal UE accesses a network through 5G new radio. A 5G access network device is deployed on a satellite, and is connected to a terrestrial core network through a radio link. In addition, there is a radio link between satellites, to implement signaling exchange and user data transmission between access network devices. Network elements in FIG. 2 and interfaces of the network elements are described as follows.

A terminal device is a mobile device that supports 5G new radio, and is typically a mobile device such as a smartphone and a pad. The terminal device may access a satellite network through an air interface and initiate a service such as a call or network access.

A 5G access network device mainly provides a radio access service, schedules a radio resource for an access terminal, provides a reliable wireless transmission protocol and data encryption protocol, and the like, and is, for example, a base station.

5G core network provides services such as user access control, mobility management, session management, user security authentication, and charging. The 5G core network includes a plurality of functional units, and may be divided into a control plane functional entity and a data plane functional entity. An access and mobility management unit (AMF) is responsible for user access management, security authentication, and mobility management. A user plane function (UPF) is responsible for functions such as managing user plane data transmission and traffic statistics.

A terrestrial station is responsible for forwarding signaling and service data between a satellite access network device and a 5G core network.

5G new radio is a radio link between the terminal and the access network device.

An Xn interface is an interface between the 5G access network device and the access network device, and is mainly for signaling exchange such as handover.

An NG interface is an interface between the 5G access network device and the 5G core network, and is mainly for exchanging signaling such as NAS of the core network and service data of users.

Terms used in this disclosure are first briefly described, to help understand embodiments of this disclosure.

1. SSB: The SSB includes a primary synchronization signal (PSS), a secondary synchronization signal (SSS), and a physical broadcast channel (PBCH), and provides, for a UE, downlink synchronization of a cell and basic configuration information of the cell. The PBCH carries a master information block (MIB) of the cell, and the MIB indicates whether a system information block type 1 (SIB1) exists. The SSB appears regularly in frequency domain, that is, the SSB may appear at a specific interval. After the UE is powered on, the UE may search for a cell at the interval.

2. NR beam sweeping: A frequency in NR is higher, and a transmission loss of a high-frequency carrier is large. Therefore, beamforming needs to be performed to increase a transmission distance of a radio signal. Because a coverage angle of each beam is limited, sweeping is performed by using a plurality of beams in the NR to cover a service range of an entire cell. Beam sweeping means that physical channels or reference signals are sent by using beams in different directions at different moments. A plurality of SSBs usually need to be sent in one cell to complete one beam sweeping. Beams in a maximum of 64 directions may be configured for the SSB.

3. SSB index and beam position binding: If an SSB index is bound to a beam position, ground beam positions need to be divided, and each beam position corresponds to at least one satellite identifier ID and SSB index. When a satellite performs broadcast beam sweeping, a corresponding beam position set is determined based on the satellite ID, and then an SSB information block is delivered based on the SSB index corresponding to the beam position. An implicit prerequisite herein is that the satellite needs to store a table about beam position information in advance for broadcast beam sweeping. In a broadcast beam sweeping process, because the satellite moves, the satellite needs to adjust a beam direction, to execute a staring service on the beam position, and ensure that a same broadcast message, for example, the SSB index, is delivered to a same beam position.

4. SSB index and beam binding: If an SSB index is bound to a beam, for example, each beam is bound to one SSB index, after determining a beam direction, a satellite may directly obtain, based on a mapping table that is of the satellite and that is of an SSB index and a beam, an SSB index to be delivered by the satellite, and finally complete coverage area sweeping.

A manner of binding the SSB index and the beam position belongs to an earth-fixed manner, and the satellite needs to store a large number of broadcast beam codebooks or have a strong codebook calculation capability, to implement continuous beam direction adjustment. A manner of binding the SSB index and the beam belongs to a satellite-fixed manner, and is simple to implement for the satellite. In embodiments of this disclosure, a beam sweeping method uses the satellite-fixed manner.

For a broadcast beam in a satellite-fixed scenario, a coverage area of the broadcast beam is gradually switched during sweeping.

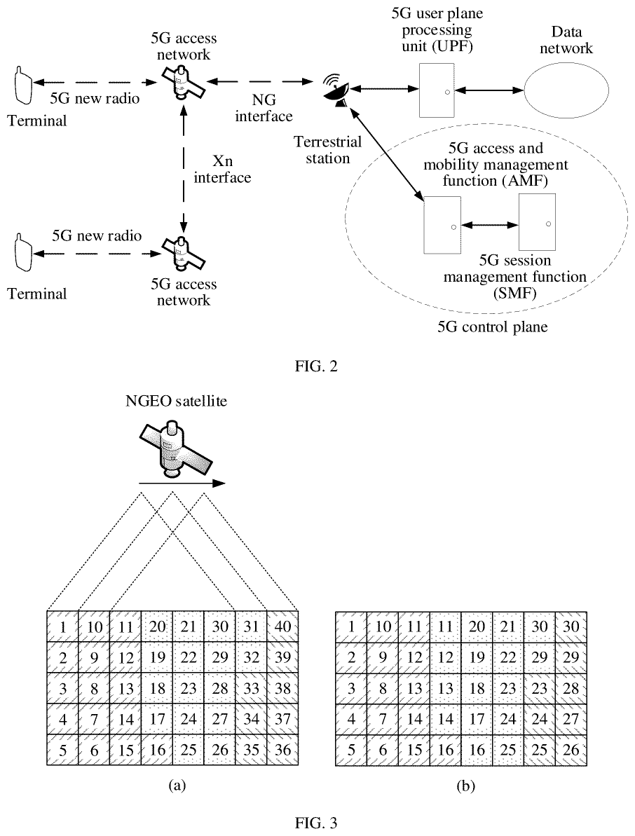

FIG. 3 is a diagram of satellite broadcast beam sweeping. As shown in FIG. 3, (a) in FIG. 3 shows a beam position number of satellite broadcast beam sweeping, and (b) in FIG. 3 shows a beam index corresponding to the beam position number.

Based on a broadcast beam sweeping result in the foregoing example, it can be learned that, during satellite movement along a movement direction, when a coverage area is switched, beam IDs in a previous column are repeated, and a feature of reverse sweeping is presented. A correspondence between the beam position number and the SSB index is shown in Table 1.

TABLE 1

| | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|
| Beam | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 | 25 | 26 | 27 | 28 | 29 |
| number | | | | | | | | | | | | | | | | | | | | | | | | | | | | | |
| position | | | | | | | | | | | | | | | | | | | | | | | | | | | | | |
| SSB index | 1 | 2 | 3 | 4 | 5 | 6 | 7 | 8 | 9 | 10 | 11 | 12 | 13 | 14 | 15 | 16 | 14 | 13 | 12 | 11 | 20 | 19 | 18 | 17 | 16 | 25 | 24 | 23 | 22 |

It can be learned from the table that there are two cases.

Case 1: A plurality of beam positions correspond to a same SSB index. For example, both a beam position 14 and a beam position 17 correspond to an SSB index 14.

In this case, a UE access process is as follows.

Step 1: In an SSB sweeping period 1, a network side delivers the SSB index 14 to the beam position 14. In an SSB sweeping period 2, the network side delivers the SSB index 14 to the beam position 17.

Step 2: Terminals at the beam position 14 and the beam position 17 both send preamble sequences based on an RO corresponding to the SSB index 14.

Step 3: An access network device receives the preamble sequence sent by the terminal, and deduces, based on a correspondence between the SSB index and a beam of the RO and a mapping relationship between the current beam position and the SSB index, that the terminal is located in the beam position 17. Therefore, a beam direction 14 is used to point the beam position 17 to deliver a random access response (RAR) message.

In conclusion, because a beam direction corresponding to the UE at the beam position 14 is a beam 14, the access network device delivers the RAR by using the beam direction 14. Consequently, the UE at the beam position 14 cannot receive the RAR, and access fails. Even if the UE repeatedly sends the preamble sequence, the access network device still cannot obtain an actual position of the UE. Consequently, an access procedure cannot be successfully completed.

Case 2: A same beam position corresponds to a plurality of SSB indexes.

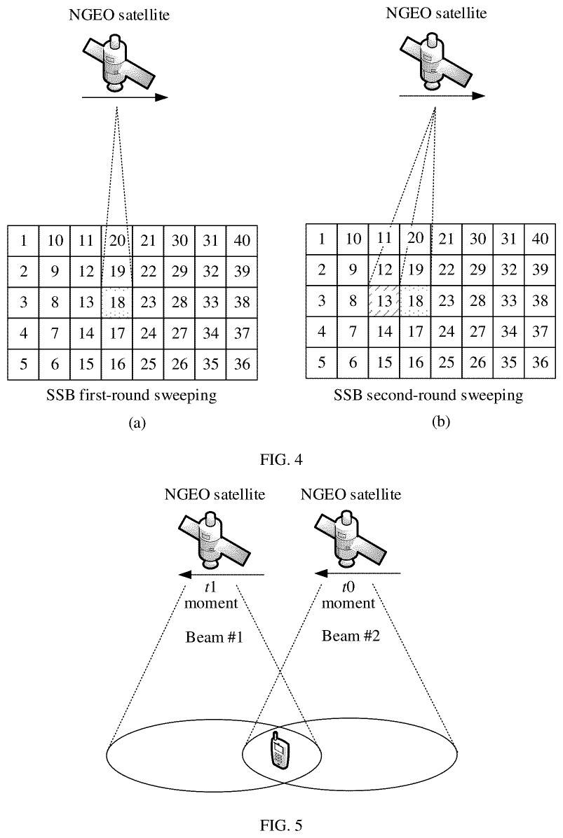

FIG. 4 is a diagram of satellite broadcast beam sweeping. As shown in (a) in FIG. 4, when the coverage area is not switched, a beam position 18 corresponds to an SSB index 18. As shown in (b) in FIG. 4, after the coverage area is switched (the coverage area is shifted rightwards by one beam position), the beam position 18 needs to be served by using a beam 13, that is, the beam position 18 corresponds to an SSB index 13.

Step 1: For the beam position 18, in a sweeping period 1, the beam 18 is used for sweeping, and the SSB index 18 is delivered; and in an SSB sweeping period 2, the beam 13 is used for sweeping, and the SSB index 13 is delivered.

Step 2: For terminal devices, some UEs in the beam position 18 send preamble sequences based on an RO corresponding to the SSB index 13, and the other UEs send preamble sequences based on an RO corresponding to the SSB index 18.

Step 3: After receiving the preamble sequence, an access network device separately returns RAR messages to the UEs by using a beam direction 13 and a beam direction 18 (where beam positions pointed to are the beam position 18 and the beam position 23).

In conclusion, because the satellite separately sends the RARs to the beam position 18 and the beam position 23, some UEs in the beam position 18 cannot receive the RAR sent to the beam position 23, resulting in an access failure. Even if the UE repeatedly sends the preamble sequence, the access network device still cannot obtain an actual position of the UE. Consequently, an access procedure cannot be successfully completed.

Based on the foregoing analysis, as the satellite moves, the coverage area of the satellite is switched, and the UE sends a preamble sequence based on a beam of a current beam position. Consequently, the access network device may not be capable of determining an actual position of the UE, and the access procedure is affected.

In an NR system, during SSB beam selection, SSS signals need to be measured. An SSB whose SS-reference signal received power (RSRP) is greater than a threshold is finally selected. If the measured SS-RSRP is not greater than the threshold, an SSB is randomly selected.

A current new radio (NR) beam sweeping solution is not applicable to an NTN system.

FIG. 5 is a diagram of UE beam selection in an NTN system. As shown in FIG. 5, if the UE selects a beam #1, as the satellite moves, the UE leaves a coverage area of the beam #1, and beam switching in the access process may occur. Consequently, the access network device cannot accurately determine a downlink beam direction based on a mapping relationship between an SSB and an RO. Consequently, the network side cannot obtain the actual position of the UE, and the access procedure cannot be successfully completed.

To avoid beam switching in the access process, that is, to complete a sweeping process under a same beam, coverage time of a selected beam needs to be adequate. For example, for a beam whose coverage area is a diameter of 24 km, maximum coverage time of the beam is about 3 s. In other words, maximum duration for delivering a same SSB index by using one beam is 3 s. If remaining service time of an SSB beam selected by the UE is short, total access time is greater than the remaining service time of the access beam. In other words, beam switching occurs in the access process. Therefore, when selecting the SSB beam, the UE needs to consider the movement direction of the satellite, to ensure that the remaining service time of the beam is adequate, and avoid in advance a beam switching problem in the access process caused by satellite movement.

In conclusion, for an NTN communication system, when remaining service time of a beam corresponding to a synchronization signal block (SSB) selected by a terminal device (UE) is less than access time of the UE, in a UE access process, beam switching is caused by satellite movement, resulting in a UE access interruption.

In view of this, this disclosure provides a method for accessing an NTN, to ensure that a UE can select a proper beam and complete access under a same beam, thereby avoiding beam switching in an access process and ensuring smooth access.

The following describes the technical solutions in this disclosure.

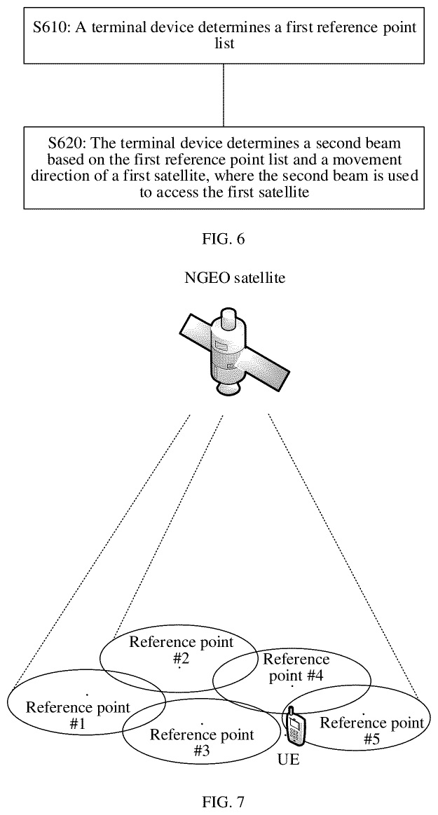

FIG. 6 is a diagram of a method for accessing an NTN provided in this disclosure.

S610: A terminal device determines a first reference point list.

First, the first reference point list and a first reference point are described.

The first reference point list includes a plurality of first reference points.

The first reference point is a point within a beam coverage area of a first beam projected onto the ground, or the first reference point is a projection point in the coverage area of the first beam projected onto the ground.

The first beam is any one of a plurality of first beams determined by a first satellite.

It may be understood that a point within beam coverage of each of the plurality of first beams projected onto the ground may be referred to as the first reference point. In other words, the plurality of first beams are projected onto the ground, so that the plurality of first reference points are generated, and the plurality of first beams are in one-to-one correspondence with the plurality of first reference points.

FIG. 7 is a diagram of a first reference point according to an embodiment of this disclosure.

As shown in FIG. 7, a reference point #1, a reference point #2, a reference point #3, a reference point #4, and a reference point #5 are examples of the plurality of first reference points. The reference point #1, the reference point #2, the reference point #3, the reference point #4, and the reference point #5 correspond to five first beams respectively.

For example, the first reference point may be a center point within the beam coverage area of the first beam projected onto the ground, or may be any point within the beam coverage area.

It should be noted that all the first reference points are at same relative positions within the beam coverage areas.

The following describes how the terminal device determines the first reference point list.

In a possible implementation, an access network device sends the first reference point list to the terminal device. Correspondingly, the terminal device receives the first reference point list from the access network device.

For example, the access network device sends the first reference point list by using a broadcast message.

For example, the first reference point list may be carried by using a SIB19 message, or may be carried by using another SIB, and is sent to the terminal device by using the broadcast message. This is not limited in this embodiment of this disclosure.

In this disclosure, the first reference point list may be represented in the following three manners.

Manner 1: A position of the first reference point is represented by using an absolute position.

For example, the first reference point may be represented by using IE beam ReferenceLocationk.

Manner 2: A position of the first reference point is represented by using a relative position.

For example, the relative position may be a position of ReferenceLocation-r17, and the position of the first reference point relative to ReferenceLocation-r17 may be represented as IE beamReferenceLocationOffsetk. The relative position may alternatively be another position. This is not limited in this embodiment of this disclosure.

Manner 3: Positions of the first reference points are represented in forms of an absolute position and an offset value. For example, one of the plurality of first reference points may be represented by using an absolute position, and another first reference point is represented by using an offset value of a distance between the absolute position and the another first reference point.

For example, a first reference point in a cell is broadcast by using IE ReferenceLocation-r18, and an offset value, represented by using IE beamReferenceLocationOffsetk, of a distance between another first reference point and IE ReferenceLocation-r18 is broadcast.

The foregoing three manners are merely examples for description, and do not constitute any limitation on this embodiment of this disclosure.

In a possible implementation, the access network device sends a first beam direction list to the terminal device. Correspondingly, the terminal device receives the first beam direction list from the access network device, and the terminal device determines the first reference point list based on the first beam direction list.

The following describes the first beam direction list and a first beam direction.

The first beam direction list includes directions of the plurality of first beams.

The direction of the first beam indicates an elevation angle and an azimuth angle of the first beam.

The direction of the first beam may be set to (θ, φ), where θ represents the pitch angle, and φ represents the azimuth angle.

It may be understood that each of the plurality of first beams corresponds to one first reference point, that is, the directions of the plurality of first beams are in one-to-one correspondence with the plurality of first reference points.

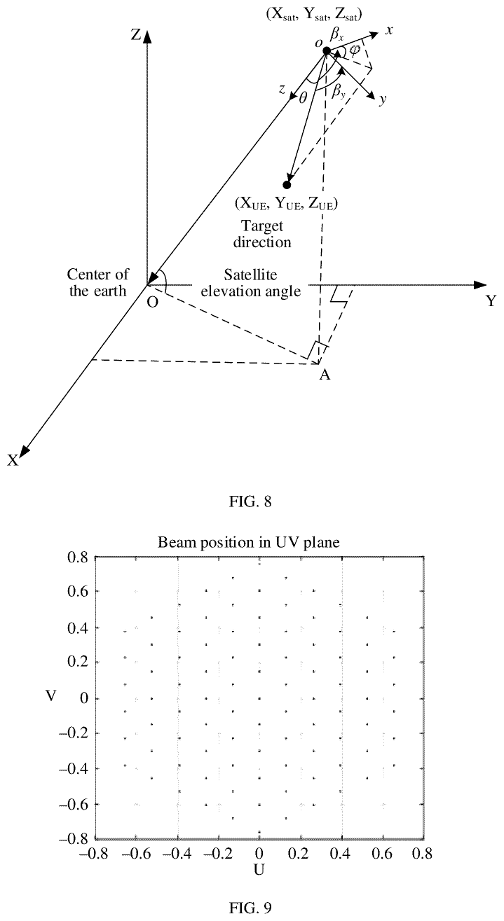

FIG. 8 is a diagram of a direction of a first beam according to an embodiment of this disclosure.

As shown in FIG. 8, a local coordinate system is established by using a satellite antenna panel, where a z-axis of the local coordinate system points to the center of the earth, and an x-axis or a y-axis may be used as a speed direction. A satellite directs a beam toward a target direction. An angle θ indicates an elevation angle, which is defined as an angle between a beam direction and the z-axis. An angle φ indicates an azimuth angle, which is defined as an angle between a positive half axis of the x-axis and a projection of the beam on an xoy plane.

For example, the access network device sends the first beam direction list by using the broadcast message.

For example, the first beam direction list may be carried by using a SIB19 message, or may be carried by using another SIB, and is sent to the terminal device by using the broadcast message. This is not limited in this embodiment of this disclosure.

In this disclosure, the first beam direction list may be represented in the following two manners.

Manner 1: The direction of the first beam is represented by using an absolute angle.

For example, the direction of the first beam may be represented by using IE BeamDirectionk, and a direction of a broadcast beam is (θ, φ), as shown in the following figure. Optionally, a value of θ is an integer ranging from 0 to 900, and a unit is 0.1 degrees. A value of φ is an integer ranging from 0 to 3600, and a unit is 0.1 degrees.

Manner 2: The direction of the first beam is represented in a full-information manner and a differential manner.

For example, a direction of one of the plurality of first beams may be represented by using full information (IE ReferenceDirection), and another first beam direction is represented by using IE BeamDirectionOffsetk, which represents a differential value between IE ReferenceDirection and the another first beam direction.

The foregoing two manners are merely examples for description, and do not constitute any limitation on this embodiment of this disclosure.

The terminal device may determine the first reference point list based on the first beam direction list, a movement direction of the first satellite, and satellite ephemeris information.

In a possible implementation, the access network device sends beam width information and beam index list information to the terminal device. Correspondingly, the terminal device receives the beam width information and the beam index list information from the access network device, and the terminal device determines the first reference point list based on the beam width information and the beam index list information.

The following describes the beam width information and the beam index list information.

The beam width information indicates a beam width of the first beam from the first satellite.

Optionally, the first beam may be a beam corresponding to a subsatellite point, or may be any one of the plurality of first beams. This is not limited in this embodiment of this disclosure.

The beam width may be represented by using θ_{3 dB}.

The beam index list information indicates a beam index list, and the beam index list is related to the beam width.

FIG. 9 is a simulation diagram of determining a beam index list based on a beam width according to an embodiment of this disclosure.

As shown in FIG. 9, an example in which a beam width θ_{3 dB} is 10 degrees and a sweeping angle is 60 degrees is used. Beam arrangement shown in FIG. 9 may be obtained by laying out beams in a regular hexagon manner based on a 3GPP uv plane.

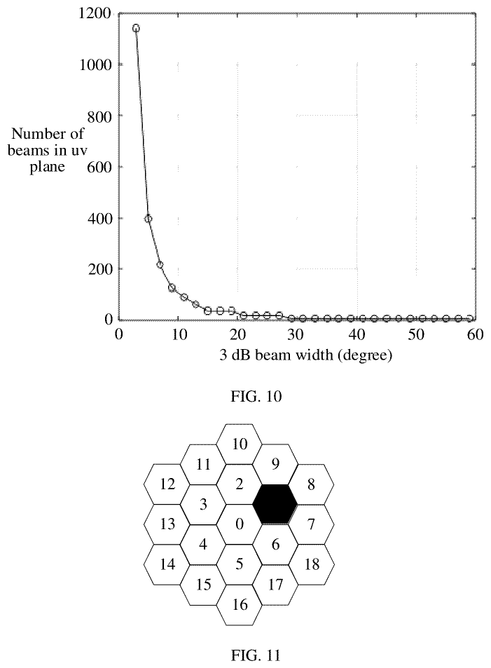

FIG. 10 is a simulation diagram of a number of beams and a beam width according to an embodiment of this disclosure.

As shown in FIG. 10, an example in which a beam width θ_{3 dB} ranges from 3 to 60 degrees is used. The beams are laid out, and a number of broadcast beams obtained through calculation ranges from 7 to 1141, and a beam index ranges from 0 to 4095, that is, 12 bits are used to represent an integer ranging from 0 to 4095.

For example, the access network device sends the beam width information and the beam index list information by using the broadcast message.

For example, the beam width information and the beam index list information may be carried by using a SIB19 message, or may be carried by using another SIB, and are sent to the terminal device by using the broadcast message. This is not limited in this embodiment of this disclosure.

The beam width information θ_{3 dB} is represented by using IE Degree Beamwidth. For example, as shown in FIG. 10, θ_{3 dB} is an integer ranging from 0 to 900; and the beam index list information is represented by using IE BeamIndex, and a value range of the beam index list information is related to the beam width.

The foregoing representation manners of the beam width information and the beam index list information are merely examples for description, and do not constitute any limitation on this embodiment of this disclosure.

The following describes a manner in which the terminal device determines the first reference point list based on the beam width information and the beam index list information.

The terminal device determines a beam arrangement manner based on the beam width information and the beam index list information, where the beam arrangement manner indicates positions of the plurality of first beams that correspond to the first reference point list and that are projected onto the ground.

FIG. 11 is a diagram of a beam arrangement manner according to an embodiment of this disclosure.

As shown in FIG. 11, in the beam arrangement manner, beam indexes are in one-to-one correspondence with projection positions on the ground, and a corresponding beam position may be determined based on the beam index.

For example, the terminal device determines the beam arrangement manner based on the beam width information and the beam index list information and according to a first rule, where the first rule is a beam arrangement rule.

The first rule may be a rule predefined by the access network device and the terminal device, or may be a rule indicated by the access network device to the terminal device. This is not limited in this embodiment of this disclosure.

For example, the first rule may be a beam index arrangement rule shown in FIG. 11. The terminal device may determine the beam position based on the beam index list information and according to the first rule. For example, a beam index 0 is located at the subsatellite point, and the beams are laid out through counterclockwise rotation numbering.

For example, the terminal device determines the beam arrangement manner based on the beam width information and the beam index list information and according to a first pattern, where the first pattern indicates arrangement of the beam indexes.

The first pattern may be prestored by the terminal device, or may be a pattern indicated by the access network device to the terminal device. This is not limited in this embodiment of this disclosure.

Optionally, the access network device sends first indication information to the terminal device, to indicate the first pattern.

For example, the access network device uses IE BeamIndexPattern to represent the pattern, and delivers the pattern to the terminal device by using the broadcast message. If the access network device indicates four patterns to the terminal device, 2-bit signaling may be used for notification. After receiving IE BeamIndexPattern, the terminal side may obtain a numbering pattern of a broadcast beam, and then determine the beam position based on IE BeamIndex.

After determining the beam arrangement manner, the terminal device may determine the positions of the plurality of first beams based on the beam index list, to determine the corresponding first reference points, so as to obtain the first reference point list.

S620: The terminal device determines a second beam based on the first reference point list and the movement direction of the first satellite, where the second beam is one of the plurality of first beams, and the second beam is used to access the first satellite.

That the terminal device determines the second beam based on the first reference point list and the movement direction of the first satellite includes the following steps.

Step 1: The terminal device determines a first vector set based on position information of the terminal device and ephemeris information of the first satellite.

The first vector set includes a plurality of first vectors, an initial point of the first vector is a position of the terminal device, and an end point of the first vector is a second reference point.

In an optional implementation, the second reference point may be any reference point in the first reference point list.

In this case, the end point of the first vector is the first reference point.

For example, the first reference point is represented by using pₖ, the first vector is represented by using dₖ, and the first reference point list includes {p₁, p₂, p₃, p₄, p₅, p₆, p₇, p₈}. In this case the first vector set is {d₁, d₂, d₃, d₄, d₅, d₆, d₇, d₈}.

In an optional implementation, the second reference point may be any reference point in a second reference point list, the second reference point list is a subset or a universal set of the first reference point list, and the first beams corresponding to the plurality of first reference points included in the second reference point satisfy RSRP threshold.

It should be understood that, when selecting a beam for accessing the first satellite, the terminal device may determine the beam based on the RSRP threshold. Before determining the first vector set, the terminal device may first select, from beams corresponding to the plurality of first reference points in the first reference point list, a plurality of first reference points corresponding to beams that satisfy the RSRP threshold to form the second reference point list.

It may be understood that the beams corresponding to the plurality of first reference points in the first reference point list may all satisfy the RSRP threshold, or may partially satisfy the RSRP threshold.

In this case, the end point of the first vector is a first reference point corresponding to a beam that satisfies the RSRP threshold.

In other words, in this manner, after determining the first reference point list, the terminal device may first screen out a beam that does not satisfy the RSRP threshold from the first reference point list.

For example, the first reference point is represented by using pₖ, the first vector is represented by using dₖ, the first reference point list includes {p₁, p₂, p₃, p₄, p₅, p₆, p₇, p₈}, and the second reference point list includes {p₂, p₅, p₆}. In this case, the first vector set is {d₂, d₅, d₈}, where beams corresponding to p₂, p₅, and p₈ satisfy the RSRP threshold.

It should be noted that determining the beam based on the RSRP threshold is merely an example, and the terminal device may alternatively select the beam based on another possible parameter or standard. This is not limited in this embodiment of this disclosure.

Step 2: Determine a first scalar set based on the first vector set and the movement direction of the first satellite.

The first scalar set includes a plurality of first scalars, and the first scalar is a projection distance of the first vector in the movement direction of the first satellite.

For example, when the first reference point is represented by using pₖ, the first vector is represented by using dₖ, the first reference point list includes {p₁, p₂, p₃, p₄, p₅, p₆, p₇, p₈}, and the first vector set is {d₁, d₂, d₃, d₄, d₅, d₆, d₇, d₈}, the first scalar set is determined based on the first vector set. The first scalar is represented by using bₖ, the movement direction of the first satellite is represented by using v, and bₖ is dₖ·v. In this case, the first scalar set is {b₁, b₂, b₃, b₄, b₅, b₆, b₇, b₈}, and when the first vector set is {d₃, d₅, d₈}, the first scalar set is {b₂, b₅, b₈}.

Step 3: Determine the second beam based on the first scalar set.

In a possible implementation, the terminal device determines a beam corresponding to a smallest first scalar in the plurality of first scalars in the first scalar set as the second beam.

For example, when the second reference point is any reference point in the second reference point list, when the second beam is determined based on the first scalar set, the beam corresponding to the smallest first scalar in the plurality of first scalars in the first scalar set may be determined as the second beam.

For example, the first reference point is represented by using pₖ, the first vector is represented by using dₖ, the first reference point list includes {p₁, p₂, p₃, p₄, p₅, p₆, p₇, p₈}, and the second reference point list includes {p₂, p₅, p₈}. In this case, the first vector set is {d₂, d₅, d₈}. The first scalar is represented by using bₖ, the movement direction of the first satellite is represented by using v, bₖ is dₖ·v, the first scalar set is {b₂, b₅, b₈}, and the terminal device determines that the smallest first scalar in the first scalar set is b₅. In this case, a beam corresponding to b₅ is determined as the second beam.

For example, when the second reference point is any reference point in the first reference point list, when the second beam is determined based on the first scalar set, the beam corresponding to the smallest first scalar in the plurality of first scalars in the first scalar set may be determined as the second beam.

For example, the first reference point is represented by using pₖ, the first vector is represented by using dₖ, the first reference point list includes {p₁, p₂, p₃, p₄, p₅, p₆, p₁, p₈}, and the first vector set is {d₁, d₂, d₃, d₄, d₅, d₆, d₇, d₈}. The first scalar set is determined based on the first vector set. The first scalar is represented by using bₖ, the movement direction of the first satellite is represented by using v, and bₖ is dₖ·v. In this case, the first scalar set is {b₁, b₂, b₃, b₄, b₅, b₆, b₇, b₈}, and the terminal device determines that the smallest first scalar in the first scalar set is b₁. In this case, a beam corresponding to b₁ is determined as the second beam.

For example, when the second reference point is any reference point in the first reference point list, when the second beam is determined based on the first scalar set, a second scalar set may be determined based on the first scalar set, where the second scalar set is a subset or a universal set of the first scalar set, and beams corresponding to the plurality of first scalars included in the second scalar set satisfy the RSRP; and the beam corresponding to the smallest first scalar in the plurality of first scalars in the second scalar set is determined as the second beam.

For example, the first reference point is represented by using pₖ, the first vector is represented by using dₖ, the first reference point list includes {p₁, p₂, p₃, p₄, p₅, p₆, p₇, p₈}, and the first vector set is {d₁, d₂, d₃, d₄, d₅, d₆, d₇, d₈}. The first scalar set is determined based on the first vector set. The first scalar is represented by using bₖ, the movement direction of the first satellite is represented by using v, and bₖ is dₖ·v. In this case, the first scalar set is {b₁, b₂, b₃, b₄, b₅, b₆, b₇, b₈}. A second scalar set {b₂, b₅, b₈} may be determined by considering whether a beam corresponding to the first scalar in the first scalar set satisfies the RSRP threshold, where beams corresponding to b₂, b₅, and b₈ satisfy the RSRP threshold. The terminal device determines that a smallest first scalar in the second scalar set is b₅. In this case, a beam corresponding to b₅ is determined as the second beam.

In another possible implementation, the terminal device determines at least one first scalar that satisfies a first threshold in the plurality of first scalars in the first scalar set; and determines a beam corresponding to one of the at least one first scalar as the second beam.

For example, when the second reference point is any reference point in the first reference point list, when determining the second beam based on the first scalar set, the terminal device may determine the at least one first scalar that satisfies the first threshold in the plurality of first scalars in the first scalar set, and determine the beam corresponding to one of the at least one first scalar as the second beam.

For example, the first reference point is represented by using pₖ, the first vector is represented by using dₖ, the first reference point list includes {p₁, p₂, p₃, p₄, p₅, p₆, p₇, p₈}, and the first vector set is {d₁, d₂, d₃, d₄, d₅, d₆, d₇, d₈}. The first scalar set is determined based on the first vector set. The first scalar is represented by using bₖ, the movement direction of the first satellite is represented by using v, and bₖ is dₖ·v. In this case, the first scalar set is {b₁, b₂, b₃, b₄, b₅, b₆, b₇, b₈}, and the terminal device determines that a first scalar that satisfies the first threshold is b₁. In this case, a beam corresponding to b₁ is determined as the second beam.

For example, when the second reference point is any reference point in the first reference point list, when determining the second beam based on the first scalar set, the terminal device may determine a second scalar set based on the first scalar set, where the second scalar set is a subset or a universal set of the first scalar set, and the beams corresponding to the plurality of first scalars included in the second scalar set satisfy RSRP; determine the at least one first scalar that satisfies the first threshold in the plurality of first scalars in the second scalar set; and determine the beam corresponding to one of the at least one first scalar as the second beam.

For example, the first reference point is represented by using pₖ, the first vector is represented by using dₖ, the first reference point list includes {p₁, p₂, p₃, p₄, p₅, p₆, p₇, p₈}, and the first vector set is {d₁, d₂, d₃, d₄, d₅, d₆, d₇, d₈}. The first scalar set is determined based on the first vector set. The first scalar is represented by using bₖ, the movement direction of the first satellite is represented by using v, and bₖ is dₖ·v. In this case, the first scalar set is {b₁, b₂, b₃, b₄, b₅, b₆, b₇, b₈}. A second scalar set {b₂, b₅, b₈} may be determined by considering whether a beam corresponding to the first scalar in the first scalar set satisfies the RSRP threshold, where beams corresponding to b₂, b₅, and b₈ satisfy the RSRP threshold. The terminal device determines that a first scalar that satisfies the first threshold in second scalar set is b₅. In this case, a beam corresponding to b₈ is determined as the second beam.

For example, when the second reference point is any reference point in the second reference point list, when determining the second beam based on the first scalar set, the terminal device may determine the at least one first scalar that satisfies the first threshold in the plurality of first scalars in the first scalar set, and determine the beam corresponding to one of the at least one first scalar as the second beam.

For example, the first reference point is represented by using pₖ, the first vector is represented by using dₖ, the first reference point list includes {p₁, p₂, p₃, p₄, p₅, p₆, p₇, p₈}, and the second reference point list includes {p₂, p₅, p₈}. In this case, the first vector set is {d₂, d₅, d₈}. The first scalar is represented by using bₖ, the movement direction of the first satellite is represented by using v, bₖ is dₖ·v, the first scalar set is {b₂, b₅, b₈}, and the terminal device determines that a first scalar that satisfies the first threshold is b₅. In this case, a beam corresponding to b₅ is determined as the second beam.

The first threshold may be predefined by the access network device and the terminal device, or may be sent by the access network device to the terminal device. This is not limited in this embodiment of this disclosure.

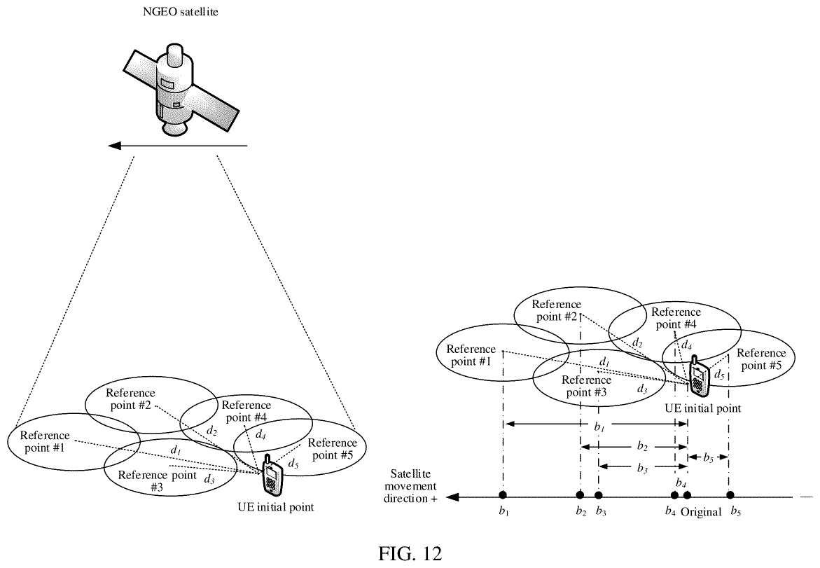

With reference to FIG. 12, the following describes an example of a process in which the terminal device determines the second beam.

FIG. 12 is a diagram of a method for determining a second beam according to an embodiment of this disclosure.

As shown in FIG. 12, a reference point #1, a reference point #2, a reference point #3, a reference point #4, and a reference point #5 are examples of the plurality of first reference points. The reference point #1, the reference point #2, the reference point #3, the reference point #4, and the reference point #5 correspond to five first beams respectively.

First, a first vector set is determined.

An initial point of a first vector is a position of a UE, and an end point of the first vector is a reference point. Therefore, vectors d₁, d₂, d₃, d₄, and d₅ may be obtained for the reference point #1, the reference point #2, the reference point #3, the reference point #4, and the reference point #5, and d₁, d₂, d₃, d₄, and d₅ form the first vector set.

A first scalar set is determined based on the first vector set.

A first scalar is a projection distance of the first vector in a movement direction. Therefore, b₁, b₂, b₃, b₄, and b₅ may be obtained, and b₁, b₂, b₃, b₄, and b₅ form the first scalar set.

The second beam is determined based on the first scalar set.

In a possible implementation, the terminal device may select a second beam corresponding to a smallest first scalar in the first scalar set.

That is, it can be learned from FIG. 12 that a satellite movement direction is a positive direction, and a reverse direction of the satellite movement direction is a negative direction. In this case, b₅ is the smallest scalar, that is, a beam corresponding to b₅ is the second beam.

In another possible implementation, the terminal device may select a second beam corresponding to a first scalar that satisfies a first threshold in the first scalar set.

For example, if b₃, b₄, and b₅ are all first scalars that satisfy the first threshold, the terminal device may select a beam corresponding to any one of the first scalars as the second beam.

It should be understood that satisfying a RSRP condition is not considered in the foregoing method, and the foregoing method is merely an example for description. When satisfying the RSRP condition needs to be considered, refer to the foregoing descriptions. Details are not described again.

It should be noted that, after receiving a plurality of beams that satisfy the RSRP condition, the terminal device cannot determine a beam, and therefore first selects a proper beam according to an existing NR standard to receive at least one of the first reference point list, the first beam direction list, the beam width information, and the beam index list information, and may determine a proper beam in the foregoing manner, to initiate random access.

According to the foregoing technical solution, the terminal device may determine the first reference point list, where the first reference point list includes points at which a plurality of beams are projected onto the ground; and determine the second beam based on the first reference point list and the movement direction of the first satellite. It should be understood that when an access beam is selected, the movement direction of the first satellite is considered, so that a beam switching problem in an access process caused by satellite movement can be avoided. A broadcast beam with a largest beam coverage area in the movement direction is selected based on a reference point in the first reference point list, to ensure smooth access.

It should be noted that the solutions provided in the foregoing embodiments may be separately used, or may be used in combination with each other. This is not specifically limited in this disclosure.

The foregoing describes in detail the broadcast beam sweeping method provided in this disclosure. The following describes a communication apparatus provided in this disclosure.

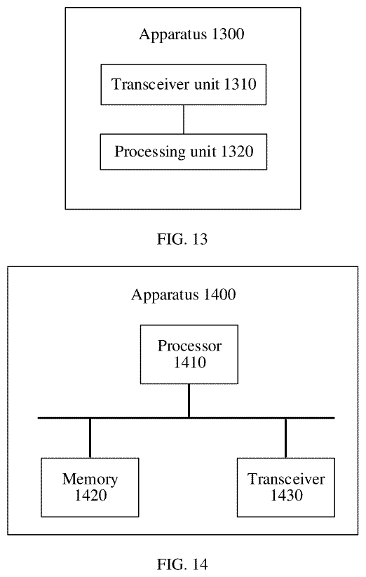

FIG. 13 is a diagram of a structure of a communication apparatus according to an embodiment of this disclosure.

The apparatus 1300 includes a transceiver unit 1310 and a processing unit 1320. The transceiver unit 1310 may be configured to implement a corresponding communication function, and the processing unit 1320 may be configured to perform data processing.

Optionally, the transceiver unit 1310 may also be referred to as a communication interface or a communication unit, and includes a sending unit and/or a receiving unit. The transceiver unit 1310 may be a transceiver (including a transmitter and/or a receiver), an input/output interface (including an input interface and/or an output interface), a pin, a circuit, or the like. The transceiver unit 1310 may be configured to perform a sending step and/or a receiving step in the foregoing method embodiments.

Optionally, the processing unit 1320 may be a processor (which may include one or more processors), a processing circuit having a processor function, or the like, and may be configured to perform a step other than sending and receiving in the foregoing method embodiments.

Optionally, the apparatus 1300 further includes a storage unit. The storage unit may be a memory, an internal storage unit (for example, a register or a cache), an external storage unit (for example, a read-only memory or a random access memory), or the like. The storage unit is configured to store instructions. The processing unit 1320 executes the instructions stored in the storage unit, so that the communication apparatus performs the foregoing method.

In an embodiment, the apparatus 1300 may be configured to perform an action performed by the terminal device in the foregoing method embodiments. For example, the apparatus 1300 may be configured to perform an action performed by the terminal device in the foregoing method 600. In this case, the apparatus 1300 may be a component of the terminal device. The transceiver unit 1310 is configured to perform receiving and sending-related operations of the terminal device side in the foregoing method embodiments. The processing unit 1320 is configured to perform processing-related operations of the terminal device in the foregoing method embodiments.

For example, the processing unit 1320 is configured to determine a first reference point list, where the first reference point list includes a plurality of first reference points, the first reference points are points within beam coverage areas of first beams projected onto the ground, the first beam is any one of a plurality of first beams determined by a first satellite, the plurality of first beams are in one-to-one correspondence with the plurality of first reference points, and the plurality of first reference points are at same relative positions within the beam coverage areas; and the processing unit 1320 is further configured to determine a second beam based on the first reference point list and a movement direction of the first satellite, where the second beam is one of the plurality of first beams, and the second beam is used to access the satellite.

It should be understood that the transceiver unit 1310 and the processing unit 1320 may further perform another operation performed by the terminal device in the foregoing method 600.

In an embodiment, the apparatus 1300 may be configured to perform an action performed by the access network device in the foregoing method embodiments. For example, the apparatus 1300 may be configured to perform an action performed by the access network device in the foregoing method 600. In this case, the apparatus 1300 may be a component of the access network device. The transceiver unit 1310 is configured to perform receiving and sending-related operations of the access network device side in the foregoing method embodiments. The processing unit 1320 is configured to perform processing-related operations of the access network device in the foregoing method embodiments.

For example, the processing unit 1320 is configured to determine a first reference point list, where the first reference point list includes a plurality of first reference points, the first reference points are points within beam coverage areas of first beams projected onto the ground, the first beam is any one of a plurality of first beams determined by a first satellite, the plurality of first beams are in one-to-one correspondence with the plurality of first reference points, and the plurality of first reference points are at same relative positions within the beam coverage areas; and the transceiver unit 1310 is configured to send the first reference point list by using a broadcast message.

For another example, the processing unit 1320 is configured to determine a first beam direction list, where the first beam direction list includes directions of the plurality of first beams, and the direction of the first beam indicates an elevation angle and an azimuth angle of the first beam; and the transceiver unit 1310 is configured to send the first beam direction list by using a broadcast message.

For another example, the processing unit 1320 is configured to determine beam width information and beam index list information, where the beam width information indicates a beam width of the first beam from the first satellite; and the transceiver unit 1310 is configured to send the beam width information and the beam index list information by using a broadcast message.

It should be understood that the transceiver unit 1310 and the processing unit 1320 may further perform another operation performed by the access network device in any one of the foregoing method 600.

It should be understood that the apparatus 1300 herein is embodied in a form of a functional unit. The term “unit” herein may refer to an application-specific integrated circuit (ASIC), an electronic circuit, a processor (for example, a shared processor, a dedicated processor, or a group processor) configured to execute one or more software or firmware programs, a memory, a merged logic circuit, and/or another appropriate component that supports the described function. In an optional example, a person skilled in the art may understand that the apparatus 1300 may be specifically the network device in the foregoing embodiments, and may be configured to perform procedures and/or steps corresponding to the network device in the foregoing method embodiments. To avoid repetition, details are not described herein again.

The apparatus 1300 in the foregoing solutions has a function of implementing corresponding steps performed by the terminal device in the foregoing method, or the apparatus 1300 in the foregoing solutions has a function of implementing corresponding steps performed by the network device in the foregoing method. The function may be implemented by hardware, or may be implemented by executing corresponding software by hardware. The hardware or software includes one or more modules corresponding to the foregoing function. For example, a transceiver unit may be replaced with a transceiver (for example, a sending unit in the transceiver unit may be replaced with a transmitter, and a receiving unit in the transceiver unit may be replaced with a receiver), and another unit such as a processing unit may be replaced with a processor, to separately perform sending and receiving operations and a related processing operation in method embodiments.

In addition, the transceiver unit 1310 may be a transceiver circuit (for example, may include a receiving circuit and a sending circuit), and the processing unit may be a processing circuit.

It should be noted that the apparatus in FIG. 13 may be the network element or the device in the foregoing embodiments, or may be a chip or a chip system, for example, a system on chip (SoC). The transceiver unit may be an input/output circuit or a communication interface. The processing unit is a processor, a microprocessor, or an integrated circuit integrated on the chip. This is not limited herein.

FIG. 14 is a diagram of a communication architecture according to an embodiment of this disclosure. A communication apparatus 1400 shown in FIG. 14 includes a processor 1410, a memory 1420, and a transceiver 1430. The processor 1410 is coupled to the memory 1420, and is configured to execute instructions stored in the memory 1420, to control the transceiver 1430 to send a signal and/or receive a signal.

It should be understood that the processor 1410 and the memory 1420 may be integrated into one processing apparatus. The processor 1410 is configured to execute program code stored in the memory 1420, to implement the foregoing functions. During specific implementation, the memory 1420 may alternatively be integrated into the processor 1410, or may be independent of the processor 1410. It should be understood that the processor 1410 may alternatively correspond to each processing unit in the foregoing communication apparatus, and the transceiver 1430 may correspond to each receiving unit and sending unit in the foregoing communication apparatus.

It should be further understood that the transceiver 1430 may include a receiver (which is also referred to as a receiver machine) and a transmitter (which is also referred to as a transmitter machine). The transceiver may further include an antenna, and there may be one or more antennas. The transceiver may alternatively be a communication interface or an interface circuit.

Specifically, the communication apparatus 1400 may correspond to the terminal device in the method 600 according to embodiments of this disclosure. The communication apparatus 1400 may include a unit for the method performed by the terminal device in the method 600. It should be understood that a specific process in which the units perform the foregoing corresponding steps is described in detail in the foregoing method embodiments, and for brevity, details are not described herein.

When the communication apparatus 1400 is a chip, the chip includes an interface unit and a processing unit. The interface unit may be an input/output circuit or a communication interface. The processing unit may be a processor, a microprocessor, or an integrated circuit integrated on the chip.

During implementation, the steps in the foregoing methods may be completed by using a hardware integrated logical circuit in the processor, or by using instructions in a form of software. The steps in the method disclosed with reference to embodiments of this disclosure may be directly performed and completed by a hardware processor, or may be performed and completed by using a combination of hardware in the processor and a software module. The software module may be located in a storage medium that is mature in the art, like a random access memory, a flash memory, a read-only memory, a programmable read-only memory, an electrically erasable programmable memory, or a register. The storage medium is located in the memory. The processor reads information in the memory and completes the steps in the method in combination with hardware thereof. To avoid repetition, details are not described herein again.

It should be noted that, the processor in embodiments of this disclosure may be an integrated circuit chip, and has a signal processing capability. During implementation, the steps in the foregoing method embodiments may be completed by using a hardware integrated logical circuit in the processor, or by using instructions in a form of software. The processor may be a general-purpose processor, a digital signal processor (DSP), an application specific integrated circuit (ASIC), a field programmable gate array (FPGA) or another programmable logic device, a discrete gate or a transistor logic device, or a discrete hardware component. The processor may implement or perform the methods, the steps, and logical block diagrams that are disclosed in embodiments of this disclosure. The general-purpose processor may be a microprocessor, or the processor may be any conventional processor or the like. The steps in the method disclosed with reference to embodiments of this disclosure may be directly performed and completed by a hardware decoding processor, or may be performed and completed by using a combination of hardware in the decoding processor and a software module. The software module may be located in a storage medium that is mature in the art, like a random access memory, a flash memory, a read-only memory, a programmable read-only memory, an electrically erasable programmable memory, or a register. The storage medium is located in the memory. The processor reads information in the memory and completes the steps in the method in combination with hardware thereof.

This disclosure further provides a computer-readable medium storing a computer program. When the computer program is executed by a computer, functions of any one of the foregoing method embodiments are implemented.

This disclosure further provides a computer program product. When the computer program product is executed by a computer, functions of any one of the foregoing method embodiments are implemented.

All or some of the foregoing embodiments may be implemented by using software, hardware, firmware, or any combination thereof. When software is used to implement embodiments, all or some of embodiments may be implemented in a form of a computer program product. The computer program product includes one or more computer instructions. When the computer instructions are loaded and executed on a computer, all or some of the procedures or functions based on embodiments of this disclosure are generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk drive, or a magnetic tape), an optical medium (for example, a high-density digital video disc (DVD)), a semiconductor medium (for example, a solid-state drive (SSD)), or the like.

In embodiments of this disclosure, the terms such as “example” or “for example” are used for representing giving an example, an illustration, or a description. Any embodiment or design scheme described as an “example” in this disclosure should not be explained as being more preferred or having more advantages than another embodiment or design scheme. Exactly, the term “example” is for presenting a concept in a specific manner.

It should be understood that, an “embodiment” mentioned throughout this specification means that particular features, structures, or characteristics related to this embodiment are included in at least one embodiment of this disclosure. Therefore, embodiments in the entire specification do not necessarily refer to a same embodiment. In addition, these particular features, structures, or characteristics may be combined in one or more embodiments by using any appropriate manner.

It should be understood that sequence numbers of the foregoing processes do not mean execution sequences in various embodiments of this disclosure. The execution sequences of the processes should be determined based on functions and internal logic of the processes, and should not be construed as any limitation on the implementation processes of embodiments of this disclosure. Names of all nodes and messages in this disclosure are merely names set for ease of description in this disclosure, and may be different in an actual network. It should not be understood that names of various nodes and messages are limited in this disclosure. On the contrary, any name that has a function that is the same as or similar to that of the node or the message used in this disclosure is considered as a method or an equivalent replacement in this disclosure, and falls within the protection scope of this disclosure.

It should be further understood that, in this disclosure, “when” and “if” mean that a UE or a base station performs corresponding processing in an objective situation, but do not constitute any limitation on time, do not require the UE or the base station to perform a determining action during implementation, and do not mean other limitations either.

In addition, the terms “system” and “network” may be used interchangeably in this specification. The term “and/or” in this specification describes only an association relationship for describing associated objects and represents that three relationships may exist. For example, A and/or B may represent the following three cases: Only A exists, both A and B exist, and only B exists.

The term “at least one of . . . ” or “at least one type of . . . ” in this specification represents all or any combination of the listed items. For example, “at least one of A, B, and C” may represent the following six cases: A exists alone, B exists alone, C exists alone, A and B coexist, B and C coexist, and A, B, and C coexist. In this specification, “at least one” indicates one or more. “A plurality of” indicates two or more.

It should be understood that, in embodiments of this disclosure, “B corresponding to A” indicates that B is associated with A, and B may be determined based on A. However, it should be further understood that determining B based on A does not mean that B is determined based only on A. B may alternatively be determined based on A and/or other information. The terms “include”, “have”, and their variants all mean “include but are not limited to”, unless otherwise specifically emphasized in another manner.

It should be understood that, in various embodiments of this disclosure, first, second, and various numbers are merely for differentiation for ease of description, and are not for limiting the scope of embodiments of this disclosure. For example, different information is differentiated.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation exceeds the scope of this disclosure.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this disclosure, it should be understood that the disclosed system, apparatus, and method may be implemented in other manners. For example, the apparatus embodiments are merely examples. For example, division of the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this disclosure may be integrated into one processing unit, each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this disclosure essentially, or the part contributing to a conventional technology, or some of the technical solutions may be implemented in the form of a software product. The computer software product is stored in a storage medium, and includes several instructions for indicating a computer device (which may be a personal computer, a server, or a network device) to perform all or some of the steps in the methods described in embodiments of this disclosure. The foregoing storage medium includes any medium that can store program code, like a USB flash drive, a removable hard disk drive, a read-only memory (ROM), a random access memory (RAM), a magnetic disk, or an optical disc.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

Terms such as “component”, “module”, and “system” used in this specification are used to indicate computer-related entities, hardware, firmware, combinations of hardware and software, software, or software being executed. For example, a component may be, but is not limited to, a process that runs on a processor, a processor, an object, an executable file, an execution thread, a program, and/or a computer. As illustrated by using figures, both a computing device and an application that runs on the computing device may be components. One or more components may reside within a process and/or a thread of execution, and a component may be located on one computer and/or distributed between two or more computers. In addition, these components may be executed from various computer-readable media that store various data structures. For example, the components may communicate by using a local and/or remote process and based on, for example, a signal having one or more data packets (for example, data from two components interacting with another component in a local system, a distributed system, and/or across a network such as the Internet interacting with other systems by using the signal).

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation exceeds the scope of this disclosure.

What is claimed is:

1. A communication method for accessing a non-terrestrial network (NTN), applied to a communication apparatus and comprising:
determining a first reference point list, wherein the first reference point list comprises a plurality of first reference points, the first reference points are points within beam coverage areas of a plurality of first beams projected onto the ground, the plurality of first beams are in one-to-one correspondence with the plurality of first reference points, and the plurality of first reference points are at same relative positions within the beam coverage areas; and
determining a second beam based on the first reference point list and a movement direction of a first satellite, wherein the second beam is one of the plurality of first beams, and the second beam is used for accessing the first satellite.

2. The method according to claim 1, wherein the determining the first reference point list comprises:
receiving the first reference point list from an access network device by using a broadcast message.

3. The method according to claim 1, wherein the determining the first reference point list comprises:
receiving a first beam direction list from an access network device by using a broadcast message, wherein the first beam direction list comprises directions of the plurality of first beams, and a direction, in the first beam direction list, of a first beam of the plurality of first beams indicates an elevation angle and an azimuth angle of the first beam; and
determining the first reference point list based on the first beam direction list, wherein the directions of the plurality of first beams are in one-to-one correspondence with the plurality of first reference points.

4. The method according to claim 1, wherein the determining the first reference point list comprises:
receiving beam width information and beam index list information from an access network device by using a broadcast message, wherein the beam width information indicates a beam width of a first beam, of the plurality of first beams, from the first satellite; and
determining the first reference point list based on the beam width information and the beam index list information.

5. The method according to claim 1, wherein the determining the second beam based on the first reference point list and the movement direction of the first satellite comprises:
determining a first vector set based on position information of the communication apparatus and ephemeris information of the first satellite, wherein the first vector set comprises a plurality of first vectors, an initial point of the first vector is a position of the communication apparatus, and an end point of the first vector is a second reference point;
determining a first scalar set based on the first vector set and the movement direction of the first satellite, wherein the first scalar set comprises a plurality of first scalars, and the first scalar is a projection distance of the first vector in the movement direction of the first satellite; and
determining the second beam based on the first scalar set.

6. The method according to claim 5, wherein the second reference point is any reference point in the first reference point list, or the second reference point is any reference point in a second reference point list, the second reference point list is a subset or a universal set of the first reference point list, the second reference point list comprises the plurality of first reference points, and the first beams corresponding to the plurality of first reference points comprised in the second reference point list satisfy a reference signal received power (RSRP) threshold.

7. The method according to claim 6, wherein when the second reference point is any reference point in the first reference point list, the determining the second beam based on the first scalar set comprises:
determining a second scalar set based on the first scalar set, wherein the second scalar set is a subset or a universal set of the first scalar set, and beams corresponding to the plurality of first scalars comprised in the second scalar set satisfy the RSRP threshold; and
determining a beam corresponding to a smallest first scalar in the plurality of first scalars in the second scalar set as the second beam.

8. A communication apparatus, comprising:
a transceiver; and
at least one processor coupled to one or more memories storing programming instructions, wherein the programming instructions are executed by the at least one processor to cause the communication apparatus to perform operations comprising:
determining a first reference point list, wherein the first reference point list comprises a plurality of first reference points, the first reference points are points within beam coverage areas of a plurality of first beams projected onto the ground, the plurality of first beams are in one-to-one correspondence with the plurality of first reference points, and the plurality of first reference points are at same relative positions within the beam coverage areas; and
determining a second beam based on the first reference point list and a movement direction of a first satellite, wherein the second beam is one of the plurality of first beams, and the second beam is used for accessing the first satellite.

9. The communication apparatus according to claim 8, wherein the programming instructions are executed by the at least one processor to cause the communication apparatus to further perform operations comprising:
receiving the first reference point list from an access network device by using a broadcast message.

10. The communication apparatus according to claim 8, wherein the programming instructions are executed by the at least one processor to cause the communication apparatus to further perform operations comprising:
receiving a first beam direction list from an access network device by using a broadcast message, wherein the first beam direction list comprises directions of the plurality of first beams, and a direction, in the first beam direction list, of a first beam in the first beam direction list indicates an elevation angle and an azimuth angle of the first beam; and
determining the first reference point list based on the first beam direction list, wherein the directions of the plurality of first beams are in one-to-one correspondence with the plurality of first reference points.

11. The communication apparatus according to claim 8, wherein the programming instructions are executed by the at least one processor to cause the communication apparatus to further perform operations comprising:
receiving beam width information and beam index list information from an access network device by using a broadcast message, wherein the beam width information indicates a beam width of a first beam, of the plurality of first beams, from the first satellite; and
determining the first reference point list based on the beam width information and the beam index list information.

12. The communication apparatus according to claim 8, wherein the programming instructions are executed by the at least one processor to cause the communication apparatus to further perform operations comprising:
determining a first vector set based on position information of the communication apparatus and ephemeris information of the first satellite, wherein the first vector set comprises a plurality of first vectors, an initial point of the first vector is a position of the communication apparatus, and an end point of the first vector is a second reference point;
determining a first scalar set based on the first vector set and the movement direction of the first satellite, wherein the first scalar set comprises a plurality of first scalars, and the first scalar is a projection distance of the first vector in the movement direction of the first satellite; and
determining the second beam based on the first scalar set.

13. The communication apparatus according to claim 12, wherein the second reference point is any reference point in the first reference point list, or the second reference point is any reference point in a second reference point list, the second reference point list is a subset or a universal set of the first reference point list, the second reference point list comprises the plurality of first reference points, and the first beams corresponding to the plurality of first reference points comprised in the second reference point list satisfy a reference signal received power (RSRP) threshold.

14. The communication apparatus according to claim 13, wherein when the second reference point is any reference point in the first reference point list, the programming instructions are executed by the at least one processor to cause the communication apparatus to further perform operations comprising:
determining a second scalar set based on the first scalar set, wherein the second scalar set is a subset or a universal set of the first scalar set, and beams corresponding to the plurality of first scalars comprised in the second scalar set satisfy the RSRP threshold; and
determining a beam corresponding to a smallest first scalar in the plurality of first scalars in the second scalar set as the second beam.

15. A non-transitory computer-readable storage medium storing computer instructions, wherein the computer instructions, when executed by at least one processor of a communication apparatus, cause the communication apparatus to perform operations comprising:
determining a first reference point list, wherein the first reference point list comprises a plurality of first reference points, the first reference points are points within beam coverage areas of a plurality of first beams projected onto the ground, the plurality of first beams are in one-to-one correspondence with the plurality of first reference points, and the plurality of first reference points are at same relative positions within the beam coverage areas; and
determining a second beam based on the first reference point list and a movement direction of a first satellite, wherein the second beam is one of the plurality of first beams, and the second beam is used for accessing the first satellite.

16. The non-transitory computer-readable storage medium storing computer instructions according to claim 15, wherein the computer instructions are executed by the at least one processor to cause the communication apparatus to further perform operations comprising:
receiving the first reference point list from an access network device by using a broadcast message.

17. The non-transitory computer-readable storage medium storing computer instructions according to claim 15, wherein the computer instructions are executed by the at least one processor to cause the communication apparatus to further perform operations comprising:
receiving a first beam direction list from an access network device by using a broadcast message, wherein the first beam direction list comprises directions of the plurality of first beams, and a direction, in the first beam direction list, of a first beam in the first beam direction list indicates an elevation angle and an azimuth angle of the first beam; and
determining the first reference point list based on the first beam direction list, wherein the directions of the plurality of first beams are in one-to-one correspondence with the plurality of first reference points.

18. The non-transitory computer-readable storage medium storing computer instructions according to claim 15, wherein the computer instructions are executed by the at least one processor to cause the communication apparatus to further perform operations comprising:
receiving beam width information and beam index list information from an access network device by using a broadcast message, wherein the beam width information indicates a beam width of a first beam, of the plurality of first beams, from the first satellite; and
determining the first reference point list based on the beam width information and the beam index list information.

19. The non-transitory computer-readable storage medium storing computer instructions according to claim 15, wherein the computer instructions are executed by the at least one processor to cause the communication apparatus to further perform operations comprising:
determining a first vector set based on position information of the communication apparatus and ephemeris information of the first satellite, wherein the first vector set comprises a plurality of first vectors, an initial point of the first vector is a position of the communication apparatus, and an end point of the first vector is a second reference point;
determining a first scalar set based on the first vector set and the movement direction of the first satellite, wherein the first scalar set comprises a plurality of first scalars, and the first scalar is a projection distance of the first vector in the movement direction of the first satellite; and
determining the second beam based on the first scalar set.

20. The non-transitory computer-readable storage medium storing computer instructions according to claim 19, wherein the second reference point is any reference point in the first reference point list, or the second reference point is any reference point in a second reference point list, the second reference point list is a subset or a universal set of the first reference point list, the second reference point list comprises the plurality of first reference points, and the first beams corresponding to the plurality of first reference points comprised in the second reference point list satisfy a reference signal received power (RSRP) threshold.
